(19) United States
(12) Patent Application Publication
(10) Pub. No.: US 2009/0259533 A1
(43) Pub. Date: Oct. 15, 2009

(54) SECONDARY MARKET FOR CONSUMER REWARDS

(75) Inventors: Brian James Utter, Seattle, WA (US); Thomas Frank Bergstraesser, Kirkland, WA (US); Alexander G. Gounares, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/101,855

(22) Filed: Apr. 11, 2008

(51) Int. Cl. G06Q 30/00

(52) U.S. Cl. 705/14

(57) ABSTRACT

System(s) and method(s) are provided to trade compensation credit(s) in a customer price incentive scheme funded through advertisement. A secondary market for rewards is established through advertisement spend from a set of disparate category advertisers (e.g., brand advertisers and product advertisers). Market liquidity is injected through an advertisement component that directs a portion of advertisement spend to issue tradable compensation credit(s) at a initial offering price. A trade platform facilitates commercialization of compensation credit(s) among a set of registered advertisers: A regulatory component provides governance and establishes pricing of traded compensation credit(s), while a brokerage component facilitates negotiation among traders. Disparate advertisers can be joined for trading based at least in part on advertiser intelligence. Trade compensation credits can be utilized, for example, to directly compensate a consumer; increase advertisement; establish an exclusivity advertiser club; or to engage a third-party serviced provider.

### TECHNICAL FIELD

The subject specification relates generally to a secondary market for consumer rewards funded through advertisement and, more particularly, to systems and methods for creation of reward liquidity and regulation of trading thereof among advertisers, merchants and service providers.

### BACKGROUND

In conventional customer-service provider interaction, a customer or agent selects a service or goods provider based on an expectation that the provider would deliver relevant and competent service which would satisfy the needs of the agent. In addition, cost-benefit analysis generally contributes to the selection process, with the agent seeking the most value among available alternative. Once a selection is made—either a service provider is engaged in a commercial transaction, or a product is bought from a merchant—the agent conveys intent in accessing the service or utilizing a product. In response to the provided intent, an adequate selection of service provider or product generally leads to service or product satisfaction. In such a commercial paradigm, service providers and merchants typically compete for agent's intent by offering quality service and products while campaigning for brand recognition, awareness and loyalty, as well as service or product differentiation.

Product advertisers or retailers conventionally further customer awareness and loyalty through immediate incentive for commercial transaction; e.g., via rebate or reward schemes. Conversely, brand advertisers rely on brand awareness and penetration to drive business transactions (e.g., a sale, a visit to an off-line store). Brand advertisers typically commercialize high-margin products and are oriented to customer segments that are comprise narrower populations such as early adopters, high-end consumers, and appeal- and technology-driven consumers. Accordingly, to avoid potential brand deterioration, brand advertisers may be reluctant to provide direct incentives to a broad spectrum of consumer to drive action. Yet, such business behavior of brand advertisers can result in maintaining largely untapped a substantial market share, with the ensuing loss in business opportunities.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject innovation provides system(s) and method(s) to trade compensation credit(s) in a customer price incentive scheme funded through advertisement. The price incentive scheme is based on an intent-compensation paradigm that directly compensates, through advertisement, a consumer in exchange for the consumer's intent in transacting with a service platform. To facilitate direct compensation of consumers from substantially any category of advertisers, in particular brand and advocacy advertisers, a secondary market for rewards is established through advertisement spend from a set of disparate category advertisers (e.g., brand advertisers and product advertisers), or advertisement engine. Trading compensation credits particularly benefits brand advertisers since it provides such advertisers with a mechanism to directly reward consumers.

Market liquidity is injected through an advertisement component that directs a portion of advertisement spend to issue tradable compensation credit(s) at an initial offering pricing. A trade platform facilitates commercialization of compensation credit(s) among a set of registered advertisers: A regulatory component provides governance and establishes pricing of traded compensation credit(s), while a brokerage component facilitates negotiation among traders. As a result of trading, pricing of compensation credit(s) adjusts from nominal value to market price, which can be driven by supply-demand forces or auctioning efforts. Disparate advertisers can be joined for trading based at least in part on advertiser intelligence collected, for example, during registration. Trade compensation credits can be utilized, for example, to (1) directly compensate a consumer; (2) increase advertisement or establish advertisement campaigns in emerging markets or that employ non-conventional technology or media; (3) establish an exclusivity advertiser club to further brand recognition or association with exclusivity without incurring substantial risks of brand deterioration that may be associated with direct compensation; or (4) engage a third-party serviced provider.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIG. 1 illustrates a block diagram of an example system in which advertisers commercialize compensation credit(s) in accordance with aspects disclosed in the subject specification.

FIGS. 2A and 2B are block diagrams of exemplary architectures of components that facilitate commercialization of compensation credit(s) according to aspects described in the subject specification.

FIGS. 3A, 3B, and 3C illustrate example scenarios of compensation trade utilization in accordance with aspects described herein.

FIGS. 4A and 4B illustrate scenarios of agent(s) compensation trade through an examples system that facilitates commercialization of compensation according to aspects disclosed herein.

FIG. 5 is a block diagram of an example advertisement management component that facilitates compensation credit(s) generation and advertisement delivery according to aspects described herein.

FIG. 6 illustrates an example intelligent component that facilitates compensation market forecasts and trader(s) matches in accordance with aspects described in the subject specification.

FIG. 7 is flowchart of an example method for trading compensation credit(s) and utilizing them to issue compensation in a consumer price incentive scheme as disclosed in the subject specification.

FIG. 8 is a flowchart of an example method for trading compensation credit(s) according to aspects described herein.

FIG. 9 is a flowchart of an example method for joining partners to trade compensation credit(s) according to aspects described herein.

FIGS. 10 and 11 illustrate computing environments for carrying out various aspects described in the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” “module,” “interface,” “platform,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As employed herein, the terms “agent,” “user,” “customer,” “player,” “participant” and the like generally refer to a human entity (e.g., a single person or group of people) that utilizes a software application (e.g., plays, participates in, or employs a computer-implemented game; or utilizes a utility software application like presentation-preparation software, data-analysis software, online investment and related business transactions, navigation software; and so on) and possesses access to computer-related communication infrastructure, computer-related systems, electronic devices, portable or otherwise, or any combination thereof. The aforementioned terms can be, and often are, hereinafter employed interchangeably.

Furthermore, the term “service” can refer to executing a software, such as using a toolbar or web-based email engine or search engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as a non-limiting illustration, as other services know to one of ordinary skill are within the scope of the subject innovation.

The term “intelligence” has two meanings: (i) it refers to information that characterizes history or behavior of a person or an entity, and to records of commercial and non-commercial activities involving a product or service, or a combination thereof, of the person or entity; and (ii) it refers to the ability to reason or draw conclusions about, e.g., infer, the current or future state of a system or behavior of a user based on existing information about the system or user. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning—to a set of available data (information) on the system or user.

As discussed in greater detail below, the subject innovation provides system(s) and method(s) to trade compensation credit(s) in a customer price incentive scheme funded through advertisement. The price incentive scheme is based on an intent-compensation paradigm that directly compensates, through advertisement, a consumer in exchange for the consumer's intent in transacting with a service platform. To facilitate direct compensation of consumers from substantially any category of advertisers, in particular brand and advocacy advertisers, a secondary market for rewards is established through advertisement spend from a set of disparate category advertisers (e.g., brand advertisers and product advertisers), or advertisement engine. Market liquidity is injected through an advertisement component that directs a portion of advertisement spend to issue tradable compensation credit(s). A trade platform facilitates commercialization of compensation credit(s) among a set of registered advertisers: A regulatory component provides governance and establishes pricing of traded compensation credit(s), while a brokerage component facilitates negotiation among traders. Disparate advertisers can be joined for trading based at least in part on advertiser intelligence collected, for example, during registration. Trade compensation credits can be utilized to directly compensate a consumer, which can benefits particularly brand and advocacy advertisers; increase advertisement; establish an exclusivity advertiser club; or to engage a third-party serviced provider.

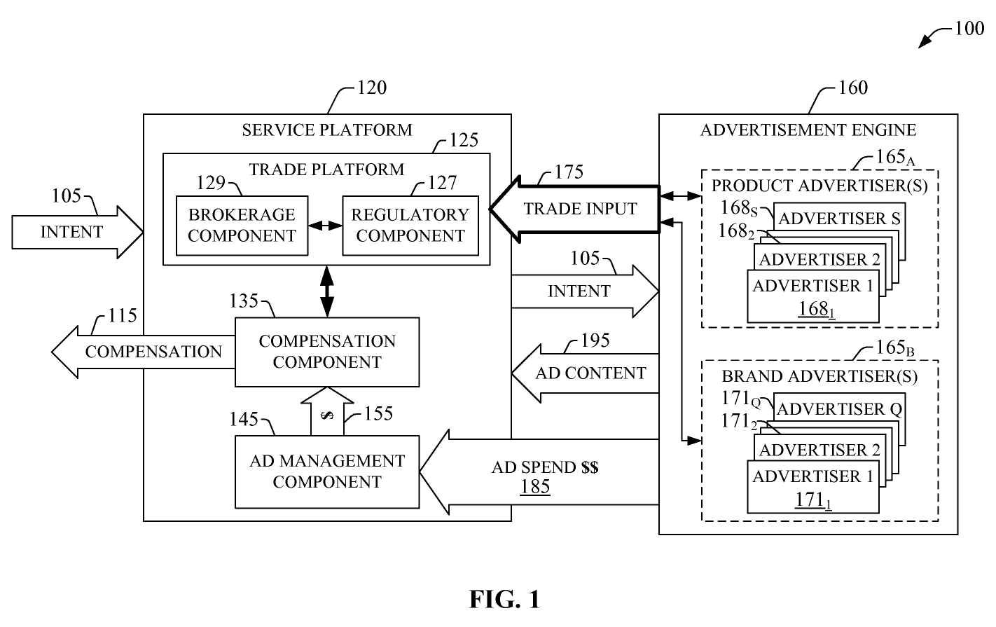

FIG. 1 illustrates a block diagram of an example system 100 in which a source of intent is compensated in exchange of the intent and advertisers commercialize compensation credit(s). In example system 100, a service platform 120 delivers a compensation 115 through ad spend in exchange for a commercial intent 105. Typically an agent (not shown) conveys intent 105 and receives compensation 115. It is to be appreciated the commercial nature of agent's intent 105 lies in the fact that the intent 105 reveals the underlying purpose (e.g., purchasing a merchandise, selecting or subscribing to a service or product, utilizing a software application, requesting/accessing for specialized advise, and so on) of accessing service platform 120 and constitutes a key to receiving service from it—the agent discloses intent 105 based on an expectation that the service platform 120 may be relevant to the agent's needs. By effecting such compensation (e.g., compensation 115), service platform 120 creates a monetary differential in favor of the customer, e.g., a user price incentive, and can distinguish itself from competitors. Such a distinction can occur at different levels: brand recognition, service/product demand, engagement of early adopters, potential for formation of business partnerships, and so on.

Service platform 120 is neither limited to a specific industry nor a specific service. Additionally, industry or service is neither limited services consumed online (e.g., through the Internet) nor offline (e.g., access to the service does not hinges on access to the Internet). A desirable characteristic of a service, or product obtained through service platform, is that the service is primarily accessed regularly (e.g., on a daily basis). Intent 105 and the service provided, or goods delivered, by service platform 120 typically are interdependent. Online service platform.—In an aspect, service platform 120 can be an online search engine, wherein the search query embodies the agent's intent in receiving a list of search results. Moreover, customer intent 105 can be related to searching for a provider or particular goods or services, and a plurality of providers may compete for knowledge of such intent (e.g., by offering rewards/incentives) in order to be presented to the customer in a favorable forum/light that will facilitate a commercial transaction transpiring between the customer and the service or product provider. In another aspect, service platform 120 can be an online portal of a technical journal, where an agent looking to retrieve a specific article provides a citation to the article (e.g., intent 105) and the publisher responds by presenting or delivering the article to the user. In another aspect, service platform 120 can be an online software application service wherein an interface customized for an agent provides the functionalities of a specific software application (e.g., payroll and benefits applications; business development and program management applications, simulation applications; online gaming applications; and so on) for a service fee. In yet another embodiment, service platform 120 can be social networking website, wherein the service platform facilitates (i) customer expression through deployment and maintenance service(s) of a webpage, and (ii) interactions among disparate customers. It should be appreciated that various additional online services can be contemplated.

Offline service platform.—Substantially any merchant or service provider that operates offline can adopt the intent-compensation paradigm described herein; for instance, car and motorcycle dealers, department stores, coffee shops, liquor stores, bookstores, pharmacies, and so on.

Compensation 115 can be provided through advertisement; e.g., ad spend 185 and ad content 195 generated by advertisement engine 160; advertisement engine 160 typically comprises product advertisers 165_{A} and brand advertisers 165_{B}. In an aspect, advertisement engine 180 can be a part of a merchant which utilizes service platform 120 as an advertisement service or broker. In another aspect, advertisement engine 180 can be an advertisement intermediary between service platform 120 and a set of disparate merchants. In yet another aspect, advertisement engine 180 can be an integral part of, and managed by, service platform 150. System platform 120 includes an advertisement management component 145 that utilizes intent 105 which is known (through explicit intent expression, for example, an agent utilizes an online translation service, or searches for a recipe in a food preparation website) or determined (e.g., extracted from an implicit expression, e.g., an agent utilizes keyword(s) in a search engine) to generate advertisement impressions that carry a compensation 115 in exchange of the intent 105.

Compensation (e.g., compensation 115) can be accessed through advertisement in multiple manners: (1) Advertisement exposure. In this scenario, the advertisement impression is conveyed to the user in the form of direct compensation, wherein the advertisement is a “conduit” for delivering the compensation. (2) Advertisement instantiation. A compensation is received by instantiating the advertisement impression; e.g., by following instructions in the advertisement such as for example, responding to an online or telephonic survey; visiting an online webpage or an offline showroom, watching a movie trailer or portion of a movie soundtrack, and so on. (3) Advertisement-driven action. Compensation is the result of a specific commercial transaction between an agent and an advertiser. It is to be appreciated that intent-driven advertisement is intrinsically targeted, thus the likelihood of an agent engaging in a transaction with the advertiser or service platform is substantially high. The likelihood of an agent taking action can be biased via the level of provided compensation 115; namely, advertisement management component 145 can present advertisement that offers a compensation 115 that is above a known or inferred engagement threshold associated with the agent that conveys intent 105. In an aspect, this mode for accessing compensation 115 can supplement (1) or (2).

To finance compensation (e.g., compensation 115) to a customer in exchange for the customer's intent (e.g., intent 105), service platform 120, through ad management component 145, can generate compensation credit(s) 155 arising from ad spend 185 and direct the compensation funding 155 to compensation component 165. Compensation credit(s) 155 is generally linked to the advertiser that incurs advertisement spend 185. It should be appreciated, however, that compensation credit(s) 155 need not be assigned to a specific advertiser, should the advertiser that incurred ad spend 185 declines or voids (e.g., credit(s) are not utilized within a predetermined time interval) its available compensation credit(s) 155. The amount of funding 155 directed towards compensation is typically determined according to a financial model that ensures a zero-sum scenario with respect to (a) ad spend directed towards compensation, (b) ad spend for advertising, and (c) credit awarded for advertising to a set of advertisers in advertisement engine 160 by service platform 120 over an advertisement cycle (e.g., a week, a month, a quarter, . . . ). It is to be noted that (c) can be viewed as funds that “prime the pump” for an advertisement engine 160, by providing subsidies for advertisement campaigns in emerging markets; focused on new products or services; or based on new advertising techniques, resources, media and technologies.

Once an advertisement model for compensation (e.g., compensation 115) delivery is selected; based at least in part on the nature—explicit or implicit expression—of the intent 105 received by service platform 120, the available intelligence on the originating agent, etc.; and consistent action has been taken by a customer, compensation component 135 delivers compensation 115. It is to be appreciated that compensation component 135 can provide compensation either online or offline, e.g., through a set of registered mobile devices. Registration of devices that can receive compensation 115 facilitates the optimization of a device's resources when conveying an advertisement that carries compensation. Furthermore, a set of devices that are utilized at the time an eligible action is undertaken by a source of intent 105 (e.g., an agent) can drive the compensation type. For example, agent utilizes an online service to trade stocks (a possible embodiment of service platform 120) in a laptop computer (e.g., device 112₁) while the agent 110 listens to music in a Zune® digital media player—that agent 110 is listening music in a Zune® device (e.g., device 112_{N}) can be gleaned from information collected by webcam operating on the agent's laptop computer and conveyed to intent processing component 135—at a specific instance agent 110 buys stock from an entertainment company. The system platform, based on the transaction, available intelligence about the user, and the fact that the user is listening to a Zune® device, result in a digital song delivered to the user email inbox (and possibly a notification to the agent's cell phone) as a compensation for conveying intent to the stock trading system. The illustrative scenario described hereinbefore displays a central advantage of the intent-compensation price incentive scheme herein disclosed with respect to conventional system: Compensation can be synergistically customized based on context and behavior, rather than established solely on user intelligence or eligible action.

As illustrated above, compensation 115 has monetary value. Monetary value can be effected (i) directly, e.g., monies are deposited in a compensation account (not shown in FIG. 1) that belongs to an agent that provides intent, or debt carried by the agent in, for example, credit card(s) is reduced by a specific amount—it should be appreciated that such credit card(s) can be issued or managed by service platform 130 or an affiliated lender (e.g., service provider) which makes debt reduction substantially more affordable and advantageous to the service platform 120. Direct payments can be electronic and effected in real time, via a wireless transmission effected through a wired or wireless communication link directly to a debit/credit card registered to the agent. Such a communication link can be substantially any type of communication link, either wired (e.g., a T-carrier like T1 phone line, an E-carrier such as an E1 phone line, a T1/E1 carrier, a T1/E1/J1 carrier, a twisted-pair link, a coaxial link, an optical fiber, and so on) or wireless (e.g., Ultra-mobile Broadband (UMB), Long Term Evolution (LTE), Wireless Fidelity (Wi-Fi), Wireless Interoperability for Microwave Access (WiMAX), etc.), or any combination thereof. The magnitude of a direct payment awarded to the agent, as compensation 115, is generally a function of multiple variables: enrollment longevity in the intent-compensation price incentive scheme effected by service platform 120, income bracket, educational level, professional activities, leisure activities, and demographics factors. Based at least in part on such parameters, compensation component 135 can determine an adequate compensation the agent. In addition, the agent can be notified that a direct payment incentive has been awarded; for example, in an online interaction a customer can receive an instant message describing the type and magnitude of the compensation 115, or in an offline interaction the customer can receive a short message service (SMS) message to the customer's cell phone, pager, or any other registered device.

Monetary value can also be effected (ii) indirectly, such as through reward points, service-specific points, platform-specific points, virtual monies or points, e.g., Microsoft® Points or substantially any other denomination, that can be used to claim a rewards either online or offline. In addition, agent 110 can be compensated with generic points (or substantially any other tokens associated with materializing a compensation 115) that facilitate claiming products or merchandise of different types and scope. Points, generic or otherwise, can be perishable or perennial, and can be transferred to a second agent (not shown). It should be appreciated that, in an aspect, generic points can be managed dynamically by service platform 120, adopting promotional value to drive a specific product or service campaign, or changing scope as a function of the point bearer (e.g., a compensated agent). An alternative or additional form of indirect monetary compensation can be effected through digital merchandise like songs; ring-tones; movies; pictures; books; magazine articles, technical or otherwise; greetings cards; games, console-based and online, single-player or multiplayer; software application add-ons such as Microsoft® Visio® stencils or custom font sets; foreign-language dictionaries; maps, secret passages, and answers to riddles for second worlds relevant to role playing games, and so on.

As discussed above compensation 115 can be instrumented through specific advertisement events; namely, (1) advertisement exposure, (2) advertisement instantiation, and (3) advertisement-driven action. Advertisement exposure and advertisement instantiation do not rely on a specific commercial transaction from the source of intent 105, and thus is a suitable instrument for compensation for both product advertisers 165_{A} and brand advertisers 165_{B}. Brand advertisers (e.g., advertisers 168₁-168_{S}) gear advertisement campaigns towards creating impressions that elicit specific consumer behavior(s) towards a specific brand; for instance, desired behavior(s) can be (a) increased awareness of the brand and word-of-mouth dissemination among consumers; (b) association of the brand with perceived success or achievement (e.g., academic, spiritual, financial, sexual) among peers; (c) association of the brand with specific solutions to social issues such as hunger, poverty, renewable energies, human and animal abuse, violence; and so on. It is to be appreciated that while brand advertisers 165_{B} are generally linked to a specific merchant, service provider, or manufactures, these advertisers can be embody advertisement agencies or advocates for a set of brands.

Alternatively, while product advertisers 165A share the brand development and awareness aspects of brand, these advertisers direct their advertisement campaigns towards consumer adoption of a specific product (e.g., market share development) and displacement of similar competitor product(s) (e.g., competitors market share mitigation). Product advertisers 165_{A} need not manufacture or process the products they advertise; a typical illustration of a product advertiser can be a retailer that sells sport shoes and apparel from various brands. Since product advertiser(s) 165_{A} need not be tied to a specific brand and merchandise products in a specific segment, such advertisers typically display brand resilience—e.g., even though the brand of a retailer fails to elicit behaviors such as (a)-(c) above, a price-value proposition of the retailer can be optimized for a particular segment of consumers. An example of the latter can be found in “dollar” stores, fast-food restaurant chains, discounted price airlines, and the like.

With reference to advertisement-driven action, such instrument for compensation can be substantially more beneficial for product advertiser(s) 165_{A}, and it is the instrument with substantially the higher likelihood of customer lock-in among actions (1)-(3) within the intent-compensation price incentive scheme promoted by service platform 120 (e.g., a merchant, a service provider, or a content provider). To make the benefits of advertisement instruments for rewards in an intent-compensation incentive scheme pervasive among substantially all classes of advertisers, service platform 120 includes a trade platform 125 that enables a secondary market platform for rewards or compensation. It is to be appreciated that compensation credit(s) 155 is highly fungible, which facilitates the trade of such credit(s). In the secondary market, ad management component 145 can sustain market liquidity: Ad spend 185 is received and apportioned it in two streams: A portion of monies 185 are retained as advertisement revenue for service platform 120 or directed toward a revenue account (not shown), and a remaining portion of monies 185 are directed towards compensation credit(s) 155. Through trade platform 125, advertisers in an advertisement engine 160 can commercialize and negotiate their compensation credit(s) 155 assigned for rebates/rewards in exchange of intent 105. Thus, brand advertiser(s) 165_{B} can trade their reward credit(s) for various currencies associated to service platform 120 that enable the brand advertiser to directly compensate a source of intent 105. Trading input, or trade transaction(s), 175 is conveyed via a communication link with the characteristics described above. Trade platform 125 includes a regulatory component 127 which provides governance, manages liquidity of compensation credit(s) 155, e.g., issues options, futures, and currencies, regulates pricing, and so on. In addition, trade platform 125 includes a brokerage component 129 that facilitates trading among disparate advertiser, such as for example negotiating compensation credit(s) 155, selling reward credit(s) at a discount, or trading currencies. It is to be appreciated that in an alternative embodiment, trade platform 125 can be external to service platform 120. In such a scenario, a single trade platform can benefit multiple online and offline service platforms.

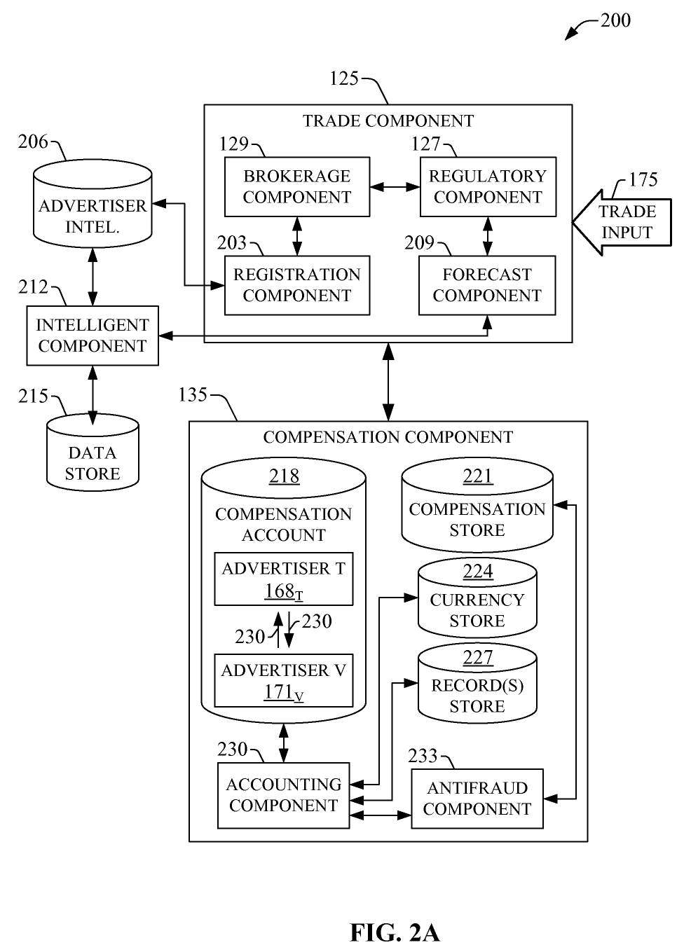

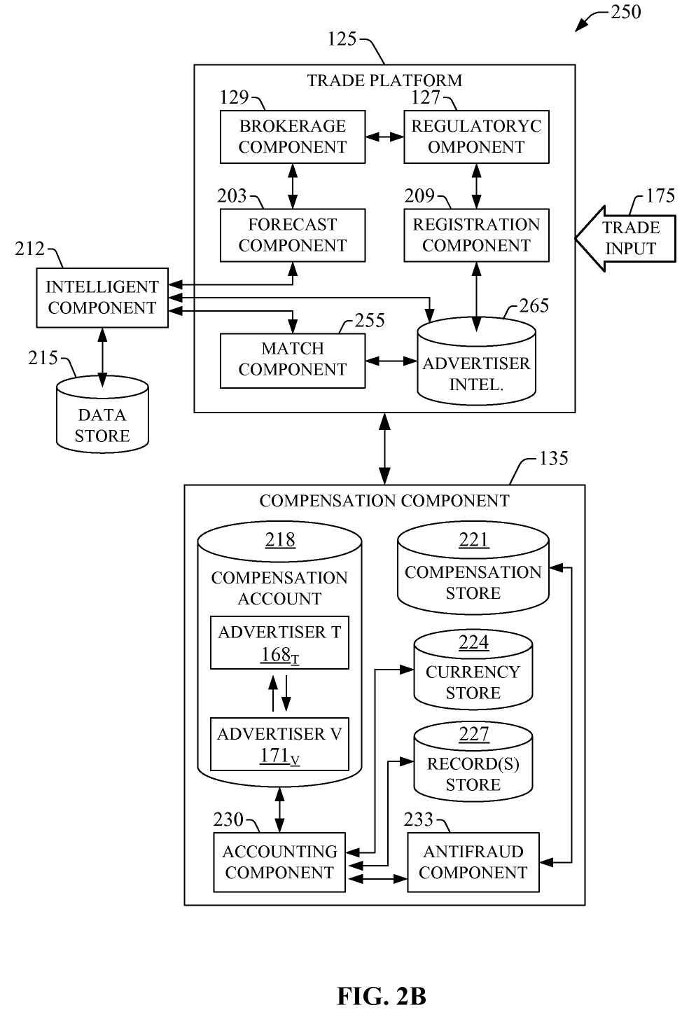

FIGS. 2A and 2B are block diagrams 200 and 250 of exemplary embodiments of trade platform 125 and compensation component 135 that enable commercialization of compensation credit(s) 155. In embodiment 200, trade platform 125 includes regulatory component 127 and brokerage component 129 as discussed above. To trade of compensation credit(s) 155 in a rewards secondary market, through trade platform 125, an advertiser (e.g., product advertiser 165_{A} or brand advertiser 165_{B}) registers with system platform 120 through registration component 203 in trade platform 125. Advertiser intelligence gathered during the registration process is stored in advertiser intelligence store, or memory, 206. Registration of advertiser(s) in advertisement engine 160 with trade platform 125 facilitates governance aspects, such as management and mitigation of trade fraud. In addition, trade platform 125 includes a forecast component 209 which can model market conditions and predict advantageous trading scenarios and pricing of rewards. Forecast component 209 relies on an intelligent component 212. Analysis and feature or pattern mining of advertiser trading trends can be implemented by intelligent component 212 to support forecast component 209. In addition, intelligent component 212 can utilize supplemental data that can facilitate intent 105 inference, and interpretation of agent's behavior according, at least in part, to advertiser intelligence 206 gathered by registration component 203. Supplemental, or extrinsic, data can reside in a data store 215, which can include data from experiment(s) and simulation(s) on behavior, customer segment influence on customer behavior and response to advertisement(s), etc. Moreover, supplemental data 215 can include data generated by intelligent component 212 in prior trading instances.

Compensation component 135 is coupled to trade platform 125 and reflects the outcomes of trading in the secondary market of rewards. Moreover, compensation component 135 delivers compensation 115 online and/or offline. To that end, compensation component 135 performs multiple tasks, which comprise (i) accounting of compensation and currency associated with registered advertisers that trade in the secondary market for rewards; (ii) retaining records associated with trade and compensation; and (iii) managing fraud mitigation such as illegitimate trade actions among advertisers (e.g., brand advertiser 168_{T} and product advertiser 171_{V}), in addition to mitigation of fraud that involves illicit claims of compensation, as well as integrity of trade and compensation records. Various components confer functionality to compensation component 135.

Monetary value of compensation 115, compensation credit(s) 155 and associated trade through trade platform 125, warrants compensation as credited by advertisement management 145 and traded is adequately awarded, accounted for, and recorded. Compensation component 135 includes an accounting component 230, an antifraud component 233, and records store 525. In addition, compensation and associated monetary and monetized instruments are stored in a set of memories: Compensation account 218, currency store 224 and compensation store 221. Accounting component 230 can account for payments related to compensation, trade profits, or currency exchange, and retain trade and compensation records in record(s) store 237. In an aspect, accounting component 230 can conduct the accounting of monetary instruments associated with compensation credit(s) 155 issued by advertisement management component 145, and compensation points (e.g., generic points, reward point, or platform specific points like Microsoft® Points) issued by compensation component 135 and associated with a specific compensation event.

In regard to compensation and trade records, such records generally include type and amount of compensation delivered to a source of intent (e.g., a human agent), or type of trade transaction and category of trade binding contract (e.g., options, futures, currency, . . . ) among trading parties. Trade records can augment available intelligence on advertisers, singularly and as a group; additionally intelligence can be retained in advertiser intelligence store 206 or data store 215. Retaining records of delivered compensation facilitates to resolve disputes that can arise from trading advertisers that claim unprocessed compensation trade transactions, or sources of intent 105 (e.g., human agents) claiming an eligible uncompensated transaction with an advertiser. Antifraud component can manage dispute resolution at least partially.

Antifraud component 233 manages security features that mitigate fraudulent trade and exploitation of compensation, and maintain trade and compensation records (e.g., resident in record(s) store 227) integrity. Antifraud component 233 can exploit various resources such as advertiser intelligence stored, for example, in agent intelligence store 206, extrinsic data stored in memory 215, intelligent component 212, and so forth. Moreover, antifraud component 233 can rely upon biometric-based verification (e.g., detection of biometric markers like voice signature, face-feature recognition like recognition of scars, moles, freckles, eye color and iris structure, and so on) to ensure that an intended advertiser reward trade (either online or offline) indeed occurs among intended traders. Antifraud component 233 can provide substantially all functionality associated with probing biometric features (e.g., cameras for bio-feature recognition, fingerprint pads, iris scanners . . . ); encrypting/decrypting compensation account and compensation store content(s), currency store 224, and record(s) store 227; etc. However, utilization of resources and security features available to other system components (e.g., regulatory component, brokerage component) can also be exploited.

In addition, antifraud component 233 can ensure trade input 175 is actually conveyed by a set of legitimate advertisers (e.g., a registered advertiser in either class 165_{A} or 165_{B}), instead of an automated computer script that emulates an advertiser (advertiser 168_{S}). Antifraud component 233 can implement variations of Turing tests to discern whether a set of counterfeit advertisers are conveying trade input 175.

Antifraud component 233 can enforce term of contractual obligations among traders and related traded monetary instruments, and can impose palliative measures such as advertiser's currency devaluation, compensation credit(s) freeze, and removal of trading privileges. To further ensure legitimate transactions, antifraud component 233 can generate a uniquely linked (e.g., via an N-bit (N a positive integer) key) token pair to identify a trader (e.g., advertiser T 168_{T}) and its counterpart trader (e.g., advertiser 171_{V}). The issued token pair facilitates recognizing the traders prior to transferring 219 compensation credit(s) 155 among traders.

FIG. 2B illustrates embodiment 250 of trade platform 125 and compensation component 135 that enables a set of advertisers to trade compensation credit(s) 155. Functionality of compensation component 135 is substantially the same as in embodiment 200. With respect to trade platform 125, a match component 255 augments the functionality of trade platform 125 and facilitates brokering trader pairs (e.g., seller/buyer). Matches predicted by match component 255 are based at least in part on advertiser intelligence 265 and extrinsic data 215. In an aspect, trade pair predictions are inferred through intelligent component 212, which can identify selling and buying trading patterns among a set of disparate advertisers, and can rely upon, at least partially, on known aspects of advertiser(s) profile, such as target market segment, historic data on advertisement performance with respect to ad campaign goals, advertisement spend magnitude over specific periods of time, volume of compensation delivered for product advertiser(s) and brand development success, as measured among consumers, for brand advertisers.

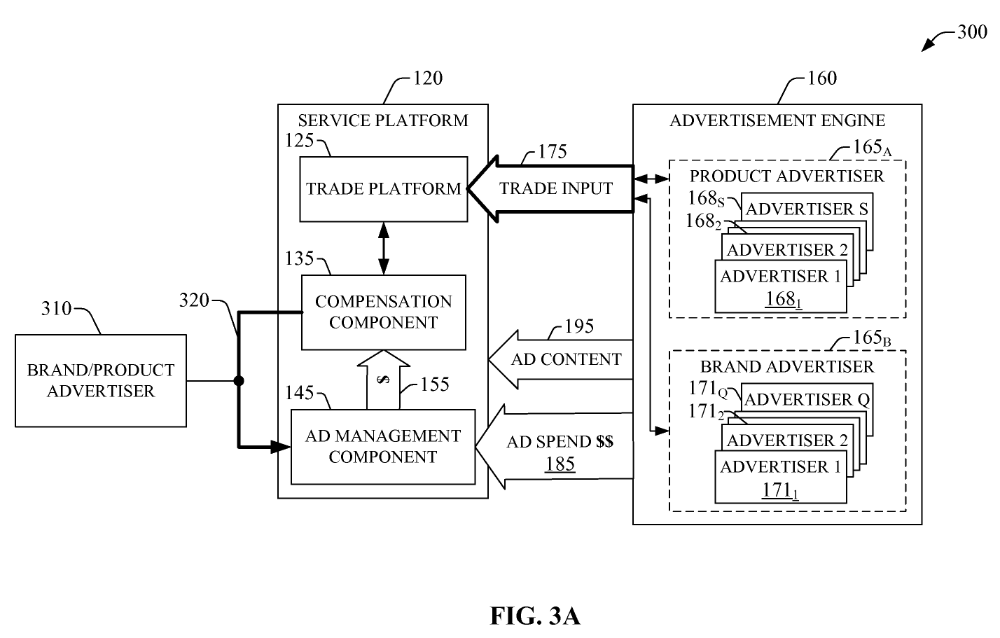

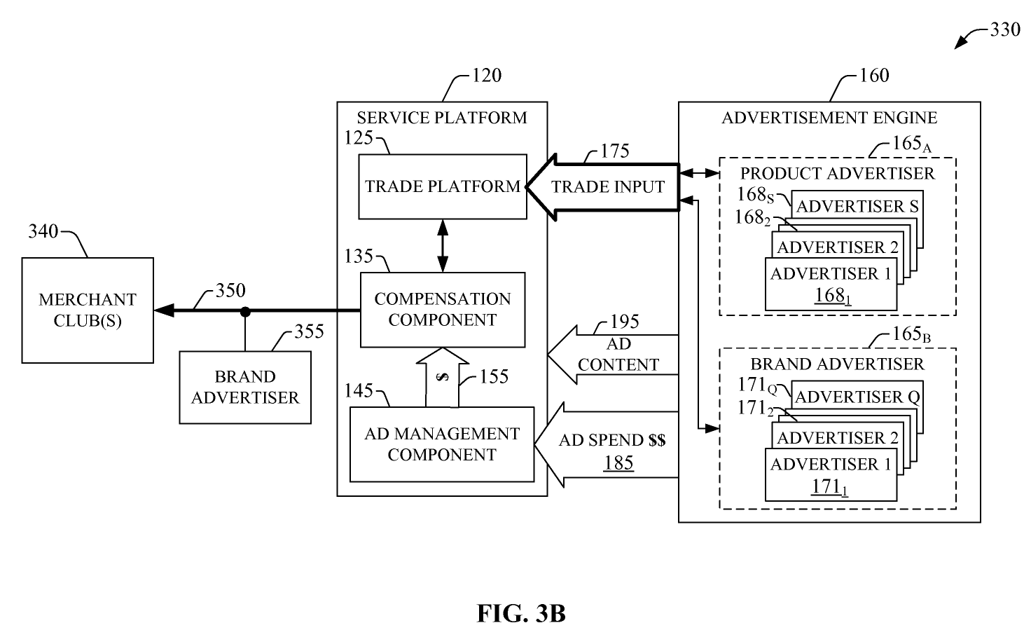

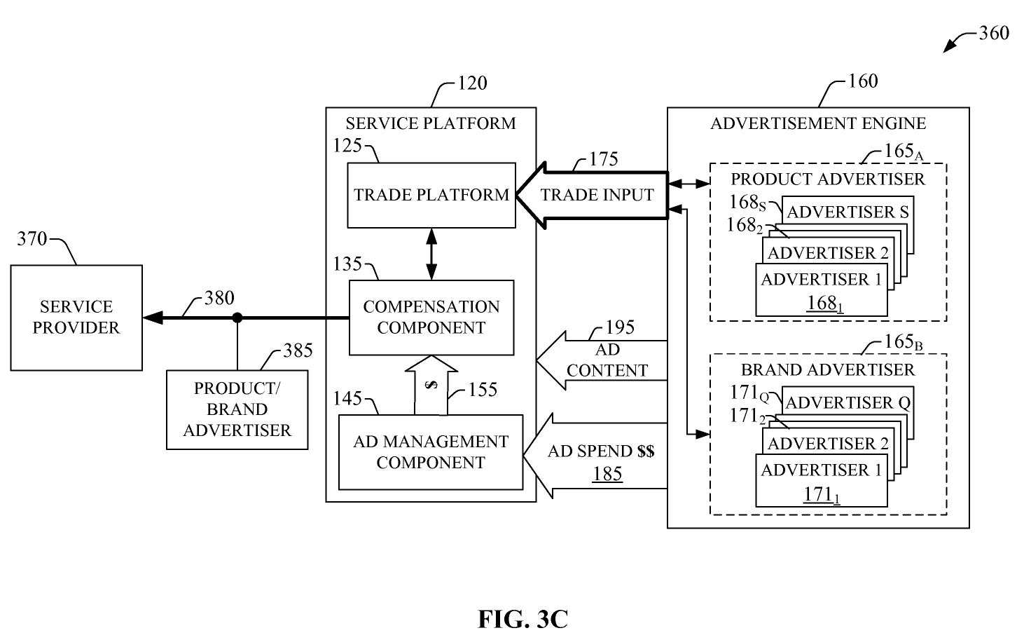

FIGS. 3A, 3B, and 3C illustrate example scenarios of compensation trade utilization. Illustrative scenarios 300, 330, and 360 are based on advertiser-to-service-platform trade. In particular, in scenario 300, trade transaction(s) 175 of a brand/product advertiser 310 are directed towards advertisement credit(s). Typically, reward trade transaction(s) 175 includes the sale of compensation credit(s) 155 assigned to, or previously negotiated by, brand/product advertiser 310 in order to generate monies to acquire advertisement 320 (e.g., ad time or ad space) through advertisement management component 134. In an aspect, monies can be generated through a sale of compensation credits 155 associated with an advertiser (e.g., advertiser Q 171_{Q} or advertiser 2 168₂) to service platform 120. The latter typically “buys back” compensation credits 155 and thus generates liquidity for the advertiser that conducted the sale transaction. In an aspect, service platform acquires compensation credit(s) 155 from a brand advertiser 165_{B} or a product advertiser 165_{A} at a discount price; the magnitude of the discount can depend at least in part on available intelligence on the advertiser that conducts the sale, or on the specific purpose of the liquidated compensation credit(s) 155. For instance, a buy-back discount for credit(s) 155 that is to be applied to engage an affiliate service provider of the service platform 120 can be smaller than compensation credit(s) liquidated in favor of a competitor of service platform 120. In addition, the magnitude of the discount proposition can be affected by the volume of transacted compensation credit(s) 155.

FIG. 3B illustrates scenario 330 wherein trade, or sale, of compensation credit(s) 155 is directed towards financing a merchant club 340. Trade transaction(s) 175 negotiates compensation credit(s) 155 assigned to, or previously negotiated by, brand advertiser 355 to generate funding 350 which is applied to merchant club(s) 340. In an aspect, funding 350 is generated through a sale of compensation credit(s) 155 to service platform 120 as discussed hereinbefore. Merchant club(s) 240 is typically associated with exclusivity and can further brand awareness. In addition, merchant club(s) 240 are particularly well suited for a customer segment that responds positively to the appeal of distinction and exclusivity rather than to advertisement-driven compensation. Even though merchant club(s) 240 is oriented towards a narrow segment of consumers, it is to be appreciated that financing arises from traded compensation credit(s) 155 amassed through advertisement campaigns of broad scope. Moreover, merchant club(s) 240 is typically better suited to mitigate customer attrition than to expand a customer base or drive customer migration from other merchants.

FIG. 3C illustrates scenario 360 in which traded compensation is directed to partner with third-party service provider(s) 370 (e.g., shipping companies, technical services). Trade transaction(s) 175 negotiates compensation credit(s) 155 assigned to, or previously negotiated by, brand/product advertiser 385 to generate funding 380 which is directed to engage service provider(s) 370. As discussed above, in an aspect, funding 380 is generated through a sale of compensation credit(s) 155 to service platform 120. It is to be appreciated that funding 380 can include compensation credit(s) 155 or reward(s) 115 associated with substantially any product advertiser 165_{A} in advertisement engine 160. Engagement of a service provider(s) 370—generally an affiliate of service platform 120 (even though a competitor can also be engaged depending on the needs of advertiser 385)—through liquidated compensation credit(s) or fungible rewards or non-liquidated credit (e.g., rewards such as Microsoft® points, digital content, discounted merchandise from a third-party content provider that may have been previously traded among advertisers in a secondary market like 125) is advantageous for the service provider(s) 370. For example, (i) a shipping company can utilize compensation credit(s) 155 received as at least a partial payment for a service to reward exceptional performance of its employees; (ii) a technical service provider, such as a computer maintenance, can utilize compensation credit(s) 155 received as a payment to reward its customers, e.g., offer software applications at a discount price; (iii) a catering service provider can utilize received compensation credit(s) 155 to reward or cover, at least in part, financial obligations with its own suppliers; and so on.

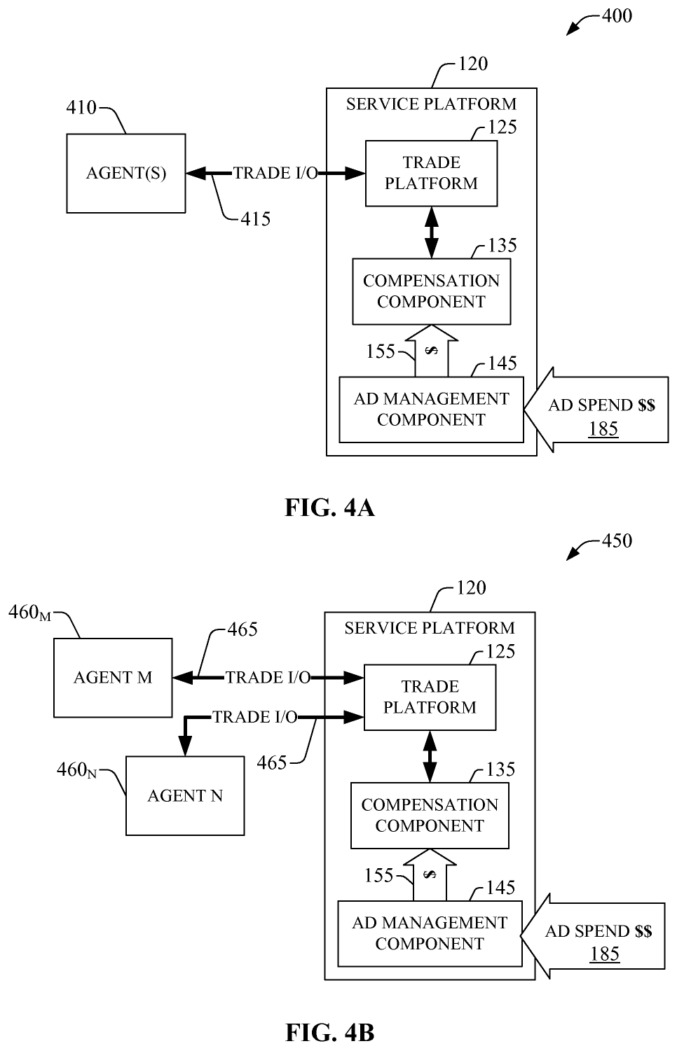

FIGS. 4A and 4B illustrate, respectively, scenarios 400 and 450 wherein agent(s) trade compensation through reward trade platform 125. In scenario 400, one or more agents, e.g., agent(s) 410 convey trade input and receive the output with trade platform 125. Trade input/out (I/O) 415 can be communicated via a communication link (schematically represented also by trade I/O 415), which provides both online and offline agents the capability to trade rewards in the secondary market platform 125. Communication can be effected according to various wireless communication protocols (e.g., LTE, UMB, WiFi, WiMAX, and the like), and via multiple wired communication link types—e.g., coaxial, twisted-pair, optical fiber—which can facilitate communication via an IP-based, packet switched protocol, and substantially any other digital or analog communication protocol. Accordingly, agent(s) 410 can utilize various devices which can either be wired or wireless (e.g., a cell phone, a laptop, tethered computer, vehicular navigation device, game console, or personal digital assistant) and with a display area that can be accessed interactively or otherwise, to convey/receive trade I/O 415. In illustrative scenario 400, agent(s) 410 can trade compensation they possess according to market prices. However, trade platform 125 can subsidize compensation for specific agents depending on commercial factor such as agent history of transactions with service platform 120, agent's longevity within intent-compensation price incentive scheme promoted by service platform, and so on.

It is to be appreciated that when compared to conventional couponing systems, the capability of an agent to participate in a secondary market of rewards, via trade platform 125, and thus switch among rewards provides at least the advantage to claim a reward that is customized to the agent's needs as dictated by the agent's context, e.g., location and time. For instance, an agent that is attending a movie theater can trade digital-content rewards for offline rewards such as goods from a concession stand within the theater. Since reward trade is a market transaction, the agent can realize a discount, or an effective profit, on the concession goods when the traded digital content is in high demand in the secondary market platform (e.g., trade platform 125).

FIG. 4B illustrates scenario 450 wherein disparate agents, like agent 460_{M} and agent 460_{N} trade rewards through trade platform 125. In such scenario, agents have an opportunity to profit for highly sought after rewards, such as “limited edition” digital content, sold-out tickets to music concerts, sport games, or prominent public figures speeches. Scenario 450 reflects an agent-to-agent market dynamics facilitated by trade platform 125. An advantage of agent-to-agent trading is that agents can update their existing compensation in view of newly developed interests on the part of the agent, or newly available rewards, e.g., provided by new content providers or advertisers (e.g., product advertisers 165A). It should be appreciated that even though system platform 120 serves as a conduit for trade on reward secondary market, the service platform 120 can regulate market prices to avoid abuse, or systematic speculation over highly sought after rewards. For example, service platform can devaluate compensation, cap prices for specific rewards, dilute valuation by issuing additional compensation, and so on.

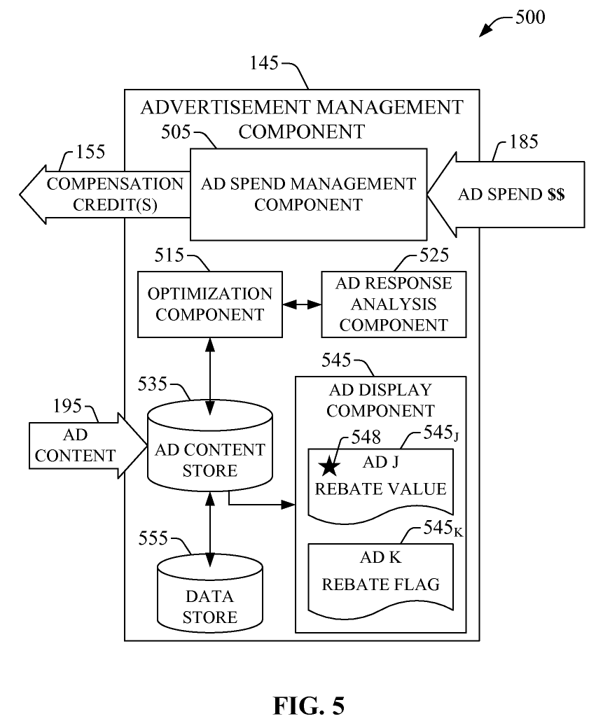

FIG. 5 is a block diagram of an example advertisement management component that facilitates compensation credit(s) generation and advertisement delivery according to aspects described herein. Illustrative component 145 comprises an ad spend management component 425 that receives and manages advertisement spending 185 from advertisement engine 180. As discussed above, a portion of the received ad spend 185 is directed to compensation credit(s) 155 for an advertiser, generally the advertiser that provides funds 185, to compensate an agent in exchange for the agent's intent in engaging in a transaction with service platform 120. Advertisement management component 145 also includes an optimization component 515 that (i) adjusts advertisement content delivered to an agent, and (ii) optimizes advertisement format in accordance with a registered device utilized by an agent that conveys intent 105 to the service platform 120. It is to be appreciated that optimization of advertisement format according to the media resources of a particular device (e.g. a device with limited display real state, or a device with limited sound capabilities such as a navigation system) provides the agent with the richest advertisement experience available to the device and thus increases the likelihood that the agent responds to the advertisement.

Optimization of advertisement format and delivery can rely on input provided by ad response analysis component 525, which can monitor response metrics for the agent when presented with a specific type of advertisement. For example, it can be determined that an agent is more likely to effect an advertisement-driven action (e.g., respond to a survey, follow a link to a beta release of a website, buy a merchandise) when the presented advertisement contains age-appropriate music or sound indicia rather than when the advertisement is solely based on imagery. As another example, it can be measured that an agent responds more favorably to advertisement instantiation when cinema, television, or music stars appear on the delivered advertisement endorsing a product or service. As yet another example, typically at check out, a cashier at a supermarket issues paper coupons for specific merchants based on the purchased goods, while for a segment of customers paper coupons are useful for a disparate segment, e.g., early adopters of advanced technology, a soft version of the coupon can increase likelihood of coupon redemption; accordingly, in an aspect of the subject innovation, advertisement response analysis component 525 can gather information via a set of cameras and microphones deployed at the cashier in the example above, while an analysis component (not shown) can identify the customer with a specific customer segment, subsequently a coupon format optimized for the customer segment is delivered; e.g., an indication to print a coupon is conveyed to the cashier or a coupon is wirelessly conveyed to customer's smart phone. In addition, information gathered through advertisement response analysis component 525 can be stored in data store 555 and provided (e.g., sold) to advertisers, such as brand advertisers 165_{B} or product advertisers 165_{A}, in order to drive trade of specific compensation associated with specific advertisement.

It is to be appreciated that optimization component can autonomously generate new advertisement content leveraging off existing content in ad content store 535. Generation of new ad content can be driven by analysis provided by ad response analysis component 525 and by trends in secondary market platform for rewards, e.g., trade platform 125. In an aspect, regulatory component 127 can issue compensation instruments redeemable through the generated advertisement in response to the market trend. Generation of digital ad content can exploit metadata adaptation of existing advertisement content or edition (e.g., addition of a soundtrack, icons, images, etc.) of such content

Advertisement management component also includes an ad display component 545 that presents an agent (e.g., agent 460_{M}) with intent-compensation incentive advertisement. Advertisement conveyed through ad display component 545 can be rendered at stationary offline points or on substantially any device utilized by the agent and registered with the service platform 120. Displayed advertisements can present a compensation flag (e.g., 545_{K}) or an exact-rebate-value (e.g., 545_{J}) flag. In addition, the advertisement can present an indication 548 that compensation reached through the ad tradable through a trade platform 125. It is to be appreciated that rebated value can be adapted to specific characteristic of the agent to which the advertisement is presented to. Advertisements can be conveyed in multiple formats (e.g., image-based (e.g., banners), text-based, sound-based, or a combination thereof) depending on the media resources available to the device (not shown) in which the advertisement is rendered, or available to an advertisement “dock” (e.g., an outdoor electronic banner) for display of intent-compensation advertisements offline. In one embodiment, ad display component 545 can be employed to notify agent(s) 410 of compensation trade opportunities, or advertised compensation after agent(s) 410 no longer utilizes service platform 120. Such embodiment adds value for the service platform 120 and advertisers 165_{A} or 165_{B} as it increases the lock-in of the user with the service platform 120 by increasing the likelihood of repeat engagements, in which new advertisements and trade opportunities can be presented to agent 110.

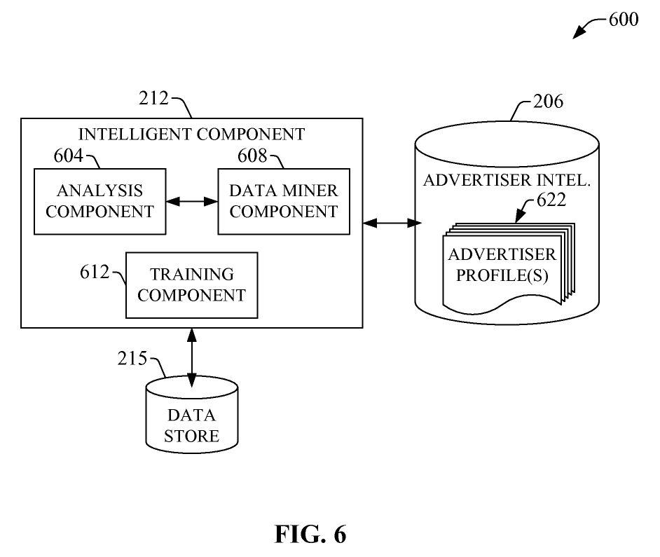

FIG. 6 an example intelligent component 212 that facilitates compensation market forecasts and trader(s) matches in accordance. Intelligent component 212 can reason, or draw conclusions, about an advertiser's target customer(s) and associated reward market segment(s) based at least in part on extrinsic data 215 (e.g., market conditions, advertisement response for specific customer segments, current fashion trends, degree of adoption of advanced technologies according to segment . . . ) available to service platform 120 and on advertiser intelligence (e.g., advertiser profile(s) 622) generally collected at the time an advertiser registers to trade rewards through trade platform 125. The inferred reward market segment(s) typically presents favorable conditions for trade and commercialization of rewards. It is to be noted that advertiser profile(s) 622 comprise historic data on trade transaction in secondary markets for compensation, business performance or advertised product/brand, etc. Alternatively, or in addition, based on substantially the same data and intelligence, intelligent component 212 can infer advertisers to trade compensation.

Intelligent component 212 can generate a probability distribution of specific states of agent's intent (e.g., intent 105) in engaging in a transaction with service platform 120 without human intervention. To infer advantageous reward market segments for an advertiser (e.g., advertiser(s) 165_{A} or 165_{B}) to trade, or suitable advertisers to specifically engage in trading, intelligent component 235 relies on artificial intelligence techniques, which apply advanced mathematical algorithms—e.g., decision trees, neural networks, regression analysis, principal component analysis (PCA) for feature and pattern extraction, spectral analysis such as wavelet expansions, cluster analysis, genetic algorithms, and reinforced and supervise machine learning—to a set of available information associated with advertisers 165_{A} or 164_{B}.

In particular, the intelligent component 212 can employ one of numerous methodologies for learning from data and then drawing inferences from the models so constructed, e.g., Hidden Markov Models (HMMs) and related prototypical dependency models, more general probabilistic graphical models, such as Dempster-Shafer networks and Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Analysis component 604 can execute at least a portion of the algorithms cited above for inferring advantageous reward market segments and trade partnerships for an advertiser. In addition, additional algorithm and computational resources can reside in analysis component 604, such as Monte Carlo simulations, game theoretic models (game trees, game matrices, pure and mixed strategies, utility algorithms, Nash equilibria, evolutionary game theory, etc.) of reward markets and advertiser behavior, and so on. Data miner 608 can further support analysis of information through data segmentation, model development for agent's behavior simulation(s) and related model evaluation(s) (e.g., generation of lift charts for discrete and continuous variables). Training component 612 utilizes available market and advertiser data and intelligence for machine learning. As available information increases, training results in improved performance of intelligence component 212 and component that utilize it.

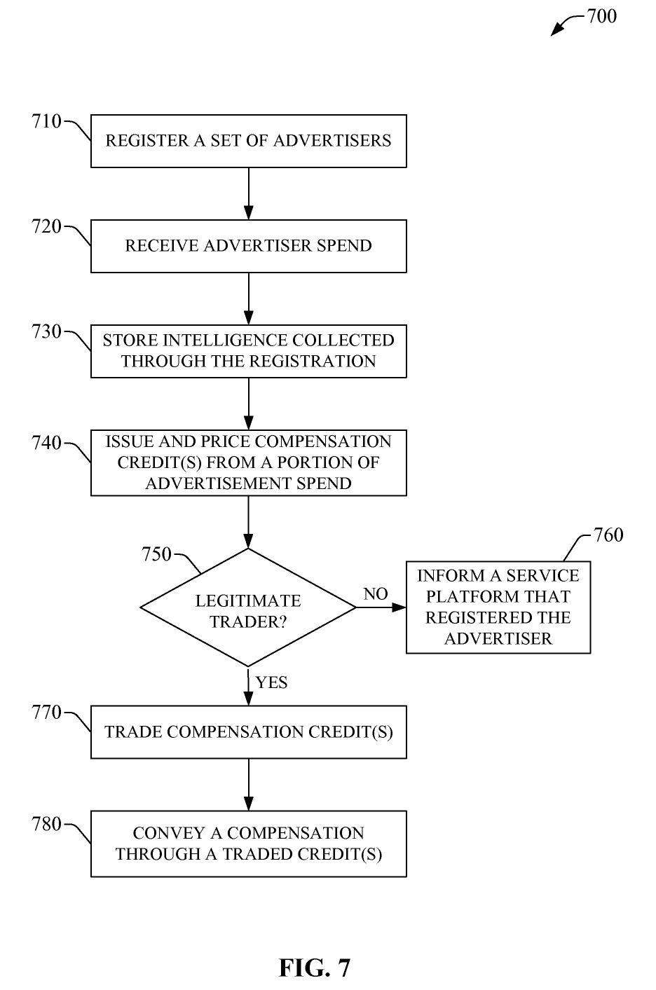

In view of the example systems, and associated aspects, presented and described above, methodologies for trading compensation credits among advertisers and between an advertiser and a service platform and utilizing the traded credits that may be implemented in accordance with the disclosed subject matter can be better appreciated with reference to the flowcharts of FIGS. 7-9. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 7 is flowchart of an example method 700 for trading compensation credit(s) and utilizing them to issue compensation in a consumer price incentive scheme as disclosed in the subject specification. At act 710, a set of advertisers is registered to traded compensation credit(s). At act 720, advertisement spend is received. At act 730 advertiser intelligence collected during the registration process is stored. At act 740, compensation credit(s) is issued from a portion of the received advertisement spend, and priced. In an aspect, compensation can be funded through advertisement spend received from at least a portion of advertisers registered in act 720. Typically, a component that manages advertisement, directs a portion of ad spend towards compensation credit(s), which creates liquidity for subsequent transactions involving trading of the issued compensation credit(s). Pricing of compensation credit(s) is typically set at a “face value,” or initial offering price. Subsequent trading (auctions, demand-supply negotiation, etc) of compensation credit(s) generally results in a market price for compensation credit(s). It should be appreciated that the face value is generally the value that the issuer (e.g., service platform 120) would negotiate compensation credit(s) with advertisers and consumer. At act 750, the legitimacy of a trader is validated. When the validation act indicates the trader is illegitimate, a service platform (e.g., service platform 120) that has registered the advertiser is informed. Generally, the information can be utilized to flag the trader and collect further information associated with illicit trade or to penalize the trader in future engagements with the service platform. Legitimacy of a trader results in compensation credit(s) being traded. At act 770, compensation credit(s) is traded. At act 780 compensation through traded compensation credit(s) is conveyed. In an aspect, act 780 can be followed by storing a record of the compensation. In an intent-compensation consumer price incentive scheme, the compensation record increases intelligence accumulated on a source of intent, which can facilitate auditing reward claims associated with missed compensation, etc.

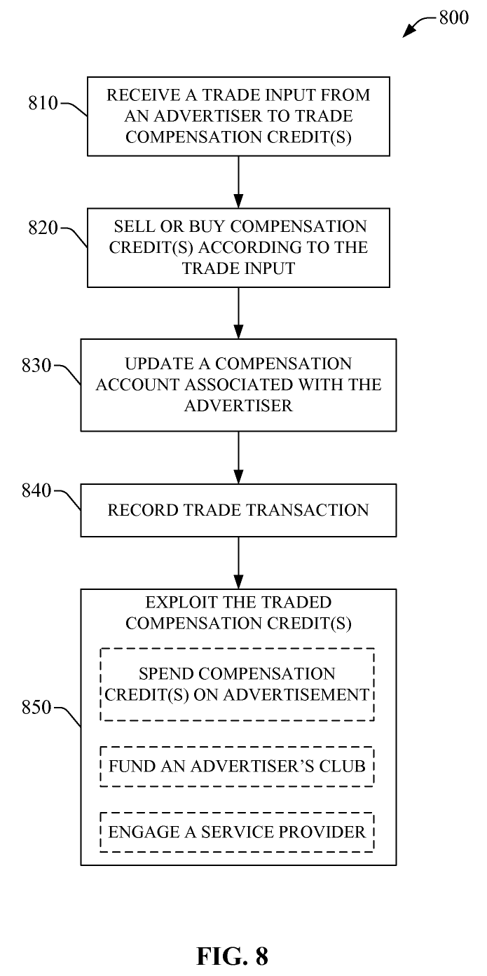

FIG. 8 is a flowchart of an example method 800 for trading compensation credit(s) according to aspects described herein. At act 810 a trade input, or trade transaction, is received from an advertiser (e.g., advertiser 168_{T}) to trade compensation credit(s) (e.g., credits 155). Trade can occur between disparate advertisers, or among an advertiser and a service provider (e.g., service platform 120) which can administer a secondary market for rewards or compensation credit(s). At act 820 compensation credit(s) are sold according to the received trade input. A sale is typically geared towards generating liquidity for the seller via compensation credit(s). Service provider, or a trade platform (e.g., trade platform 125) managed by the service provider establishes a pricing model at which transaction in act 820 proceeds. Moreover, when a transaction in act 820 occurs among advertisers, pricing is typically determined by market conditions. Thus, for either advertiser-to-advertiser or advertiser-to-service-platform transaction, pricing is generally dictated by intrinsic market forces such as demand-supply of compensation credit(s). In an aspect, in an intent-compensation consumer price incentive scheme such a balance can be affected by consumer that convey intent to a service platform that promotes such an intent-compensation business model. It is to be appreciated that demand-supply can be substantially affected by consumer segment. Pricing can also be determined in an auction (e.g., a reverse Dutch auction, an English auction). Typically, auctions of compensation credit(s) (e.g., credits 155) can be more adequate for large volume advertiser(s) that can significantly profit from auctioning large volumes of compensation credit(s). At act 830 a compensation account (e.g., compensation account 218 is updated) associated with the advertiser is updated to reflect the trade. At act 840, the trade transaction is recorded. In an aspect, transaction are retained in a record(s) store like store 227. At act 850, trade of compensation credit(s) is exploited; for instance, traded compensation credit can be sold to, or negotiated with, a service platform (via a trade platform like platform 125) in order to generate liquidity in favor of an advertiser, liquidated compensation credit(s) 155 can be utilized for financing advertisement campaigns, funding merchant or advertiser exclusivity club(s), or engaging a third-party or affiliated service or content provider. It should be appreciated that traded compensation credit(s) 155 can be utilized in additional manners, which within the scope of the system(s) and method(s) described herein, such as compensating a source of intent, as in act 770 of method 700.

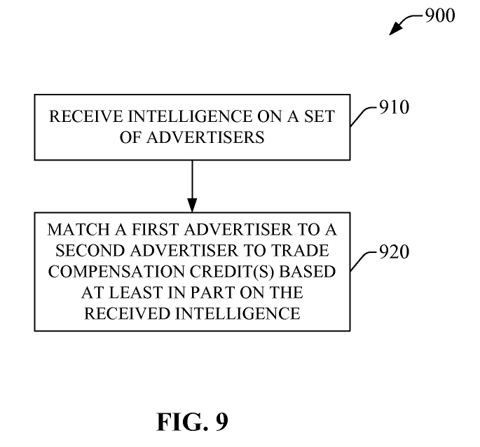

FIG. 9 is a flowchart of an example method 900 for joining partners to trade compensation credit(s) (e.g., credits 155) according to aspects described herein. At act 910, intelligence on a set of advertisers is received. In an aspect, advertiser intelligence can be gathered through a registration process to participate in trading in a secondary market for rewards (e.g., trade platform 125) offered through a service platform 120. At act 920, a first advertiser and a second advertiser are matched, based at least in part on the received advertiser intelligence, for trading compensation credit(s).

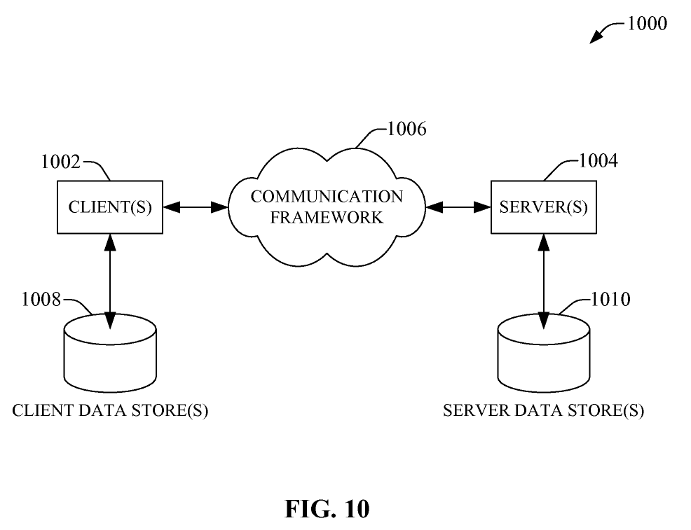

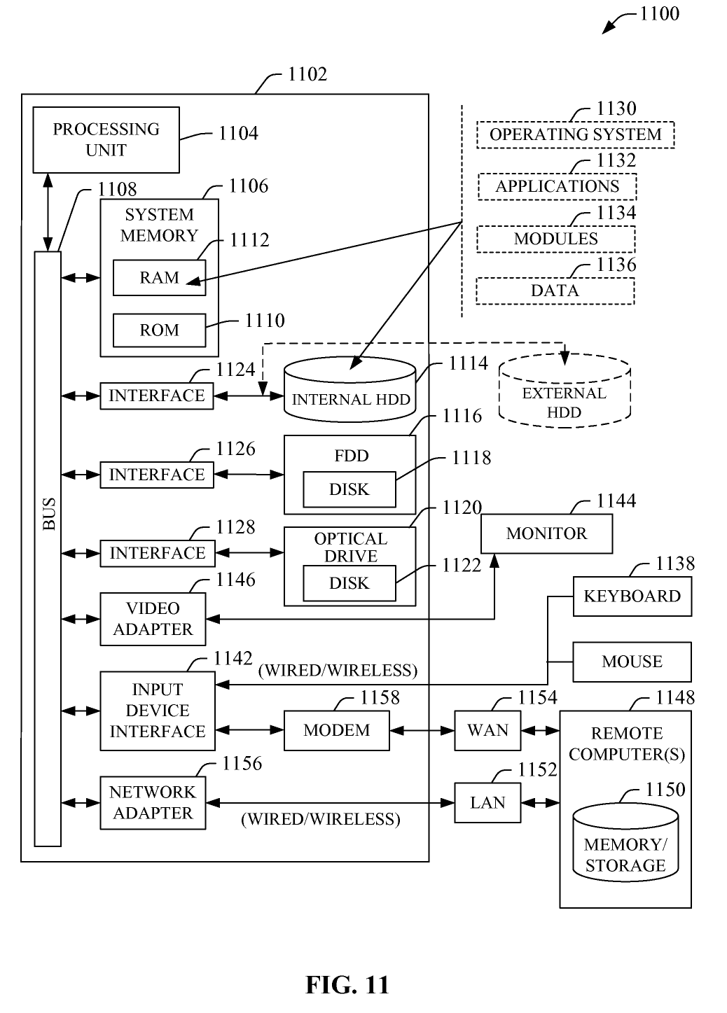

In order to provide additional context for various aspects of the subject specification, FIGS. 10 and 11 and the following discussions are intended to provide a brief, general description of suitable computing environments 1100 and 1200 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

FIG. 10 illustrates a schematic block diagram of a computing environment in accordance with the subject specification. The system 1000 includes one or more client(s) 1002. The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware and/or software (e.g., threads, processes, computing devices). The servers 1004 can house threads to perform transformations by employing the specification, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In FIG. 11, the example environment 1100 for implementing various aspects of the specification includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the specification can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 408 via an interface, such as a video adapter 1146. In addition to the monitor 444, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are example and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the terms “includes,” “has,” “possesses,” and the like are used in either the detailed description or the claims, such term is intended to be inclusive in a manner similar to the term “comprising” as “comprising” is interpreted when employed as a transitional word in a claim.

What is claimed is:

1. A system to commercialize compensation credits in an intent-compensation consumer price incentive model, comprising:
a component that receives advertisement spend and issues a compensation credit to an advertiser through a portion of the advertisement spend;
a brokerage component that enables trade of compensation credit of disparate advertisers among the disparate advertisers; and
a regulatory component that determines pricing for the transacted compensation credit.

2. The system of claim 1, further comprising a compensation component that receives a compensation credit and compensates a consumer based on the consumer's intent in engaging with a service platform.

3. The system of claim 1, the advertiser belongs to at least one of a product advertiser category or a brand advertiser category.

4. The system of claim 1, further comprising a component that registers an advertiser to trade a compensation credit.

5. The system of claim 1, wherein the determined pricing follows a supply-demand model.

6. The system of claim 1, wherein the determined pricing is dictated through an auction mechanism.

7. The system of claim 1, the auction mechanism is at least one of an English auction or a reverse Dutch auction.

8. The system of claim 1, further comprising a storage component that retains intelligence on a registered advertiser, wherein the intelligence comprises at least one of a set of historic data on compensation credits trade, an advertiser category or a target customer segment for the advertiser.

9. The system of claim 6, further comprising a component that matches a first advertiser to a second advertiser to trade a compensation credit.

10. The system of claim 7, wherein the first and second advertisers are matched based at least in part on their respective advertiser intelligence.

11. The system of claim 1, further comprising a forecast component that predicts pricing of a set of issued compensation credits.

12. The system of claim 11, wherein pricing predictions are based at least in part on at least one of a Monte Carlo simulation, a utility algorithm, a game tree, a game matrix, a pure strategy, a mixed strategy, a Nash equilibria, an evolutionary game theory.

13. The system of claim 2, the compensation component further comprising:
a component that accounts traded compensation credits;
a component that accounts a currency traded for a compensation credit;
an antifraud component that mitigates fraudulent trade of a compensation credit; and
a component that retains trade records.

14. A method for trading reward credits in an intent-compensation agent price incentive scheme, the method comprising:
registering a set of advertisers;
receiving advertisement spending from the set of advertisers;
issuing and pricing a reward credit from the received advertisement spending;
trading the reward credit among the registered advertisers; and
compensating a consumer of a service platform through the traded reward credit.

15. The method of claim 14, further comprising storing intelligence on the set of advertisers, wherein the intelligence comprises at least one of a set of historic data on compensation credits trade, an advertiser category or a target customer segment for the advertiser.

16. The method of claim 15, further comprising matching a first advertiser to a second advertiser to trade a reward credit based at least in part on the stored intelligence.

17. The method of claim 14, further comprising validating the legitimacy of the registered advertisers.

18. The method of claim 14, wherein trading the reward credit among the registered advertisers includes:
receiving a trade input from an advertiser in the set of registered advertisers;
at least one of selling or buying the reward credit according to the trade input;
updating a compensation account associated with the advertiser; and
recording the trade transaction.

19. The method of claim 18, further comprising:
generating liquidity through the reward credit; and
exploiting the generated liquidity via at least one of:
spending the traded reward credit on advertisement;
funding an advertiser's club at least in part through the traded reward credit; or
a service provided through the traded reward credit.

20. A computer readable medium having code instructions stored thereon that, when executed by a processor, cause the processor to perform the following acts:
receiving advertisement spending from a set of advertisers;
issuing and pricing a compensation credit from the received advertisement spending; and
trading the compensation credit among the set of advertiser.
